(19) United States
(12) Patent Application Publication
(10) Pub. No.: US 2007/0136731 A1
(43) Pub. Date: Jun. 14, 2007

(54) Systems and methods for prioritizing tasks

(75) Inventors: Bud J. Bennington, Lacon, IL (US); Michael R. Fetcho, Mackinaw, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/297,472

(22) Filed: Dec. 9, 2005

(51) Int. Cl. G06F 9/46

(52) U.S. Cl. 718/103

(57) ABSTRACT

A system for calculating a normalized priority rating for a task is provided. The system includes a computing platform configured to receive an indication of whether the task is a forced change. If the task is a forced change, the computing platform is configured to assign a predetermined normalized priority rating to the task. If the task is not a forced change, the computing platform is configured to receive input indicative of a plurality of task characteristics and calculate a normalized priority rating based on the task characteristics. The computing platform is also configured to provide an output indicative of the normalized priority rating.

### TECHNICAL FIELD

The present disclosure relates to systems and methods for scheduling tasks to be performed by an organization, and more particularly, to computer-implemented systems and methods for prioritizing tasks.

### BACKGROUND

The customers and shareholders of business entities such as corporations demand efficiency in all respects. Accordingly, many businesses have developed “Six Sigma” programs to recommend changes in current practices in order to increase quality in the most efficient possible manner. However, even the largest corporations have limited resources. Whenever any entity undertakes to make such a change, it necessarily forgoes, or at least delays, performance of another task that may be equally, if not more valuable.

Previously, the process of deciding which of several tasks to undertake was largely subjective and, frequently, those projects that were championed by influential individuals were moved to the forefront. Although the relative merits of similar projects (e.g., competing proposals to automate a manual process) could be compared with reference to their relative effects on a common baseline, dissimilar projects (e.g., a proposal to the servers in one division of a corporation versus a proposal to upgrade accounting software in another division) were less easily compared in terms of their effect on the overall quality of output. Consequently, the relative priority assigned to such dissimilar tasks was largely the result of subjective considerations.

Methods for normalizing the relative priorities of multiple projects have been previously developed. One such method is described in U.S. Pat. No. 5,671,361 to Brown et al. This method uses heuristic rules to determine a priority index value for each proposed task and then schedules the respective tasks based on their relative priority indices. However, the heuristic rules proposed by Brown et al. are designed only to minimize the amount of time it takes to complete multiple projects at the same time. The relative priorities of the tasks are based largely on the relative amount of time and resources that each task consumes. The heuristic rules do not take the relative values of the tasks into account. While the Brown et al. method may be used to minimize the time needed to complete a plurality of tasks, it does not provide useful guidance to an entity seeking to decide which of several proposed tasks to undertake in the first instance.

The presently disclosed systems and methods for prioritizing tasks are directed toward solving one or more of these shortcomings of the prior art systems and methods.

### SUMMARY OF THE DISCLOSURE

A system for calculating a normalized priority rating for a task is provided. The system includes a computing platform configured to receive an indication of whether the task is a forced change. If the task is a forced change, the computing platform is configured to assign a predetermined normalized priority rating to the task. If the task is not a forced change, the computing platform is configured to receive input indicative of a plurality of task characteristics and calculate a normalized priority rating based on the task characteristics. The computing platform is also configured to provide an output indicative of the normalized priority rating.

### BRIEF DESCRIPTION OF THE DRAWINGS

FIG. 1 illustrates an exemplary system environment, consistent with the present disclosure.

FIG. 2 illustrates data contained in an exemplary database system, consistent with the present disclosure.

FIG. 3 is a flow chart illustrating an exemplary method, consistent with the present disclosure.

FIG. 4 illustrates an exemplary rating screen display, consistent with the present disclosure.

FIG. 5 is a flow chart illustrating an exemplary method, consistent with the present disclosure.

FIG. 6 illustrates an exemplary classification screen display, consistent with the present disclosure.

### DETAILED DESCRIPTION

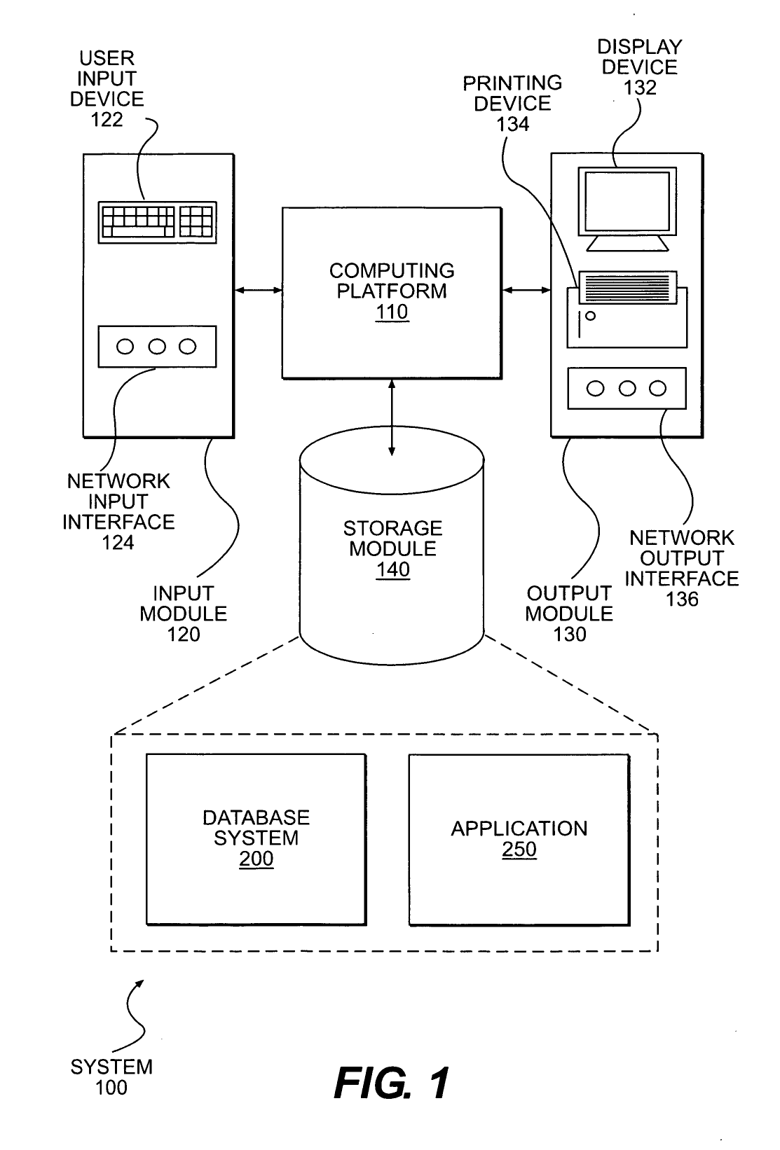

FIG. 1 illustrates an exemplary system environment 100 in which features and principles of the present disclosure may be implemented. As shown in FIG. 1, system 100 may include a computing platform 110, an input module 120, an output module 130, and a storage module 140.

Computing platform 110 may be implemented using a general purpose computer (e.g., a personal computer, server, or mainframe computer) having a processor that may be selectively activated or configured by a computer program to perform one or more methods consistent with the present disclosure. For example, computing platform 110 may include a processor device, such as a microprocessor, that executes program instructions to perform various functions.

Alternatively, computing platform 110 may be implemented using a distributed network of such processors. For example, computing platform 110 may include a plurality of computers connected in a network architecture (not shown) that may allow access to the functionality of system 100 from a plurality of distributed locations, such as distributed work sites within a corporation. The network architecture may include any type of network, or combination of networks, that facilitate communications between remote components. For example, computing platform 110 may include a plurality of computers connected by a local area network (LAN), a wide area network (WAN), a dedicated intranet, the Internet, etc.

As shown in FIG. 1, computing platform 110 may be in communication with input module 120, output module 130 and/or storage module 140. Specifically, computing platform 110 may be adapted to process input (e.g., commands, instructions and/or data, etc.) received from input module 120. Computing platform 110 may be further adapted to provide output to output module 130 for printing, display, storage and/or further communication to other system devices.

Computing platform 110 may be located in the same location or at a geographically distant location from input module 120, output module 130 and/or storage module 140. In an exemplary embodiment of the present disclosure, computing platform 110 may be connected to input module 120, output module 130 and/or storage module 140 through the use of a network architecture (not shown). For example, computing platform 110 may be connected to modules 120-140 via a LAN, WAN, a dedicated intranet, or the Internet, etc.

Input module 120 may be implemented using any of a variety of devices configured to receive and/or provide instructions, data and/or commands to computing platform 110 as input. As illustrated in FIG. 1, input module 120 may include a user input device 122 for receiving input from a human user. For example, user input device 122 may include a keyboard, a mouse or other pointing device, speech recognition software, and/or any other suitable device or application for configuring user input to be read by computing platform 110. Further as illustrated in FIG. 1, input module 110 may include a network input interface 124 operatively connected to receive input from an external computer, network and/or storage device (not shown).

Output module 140 may be implemented using any of a variety of devices configured to provide the output of computing platform 110 in a form readable by another computer and/or a human user. As illustrated in FIG. 1, output module 130 may include a display device 132 and/or a printing device 134 for receiving the output of computing platform 110. For example, the output of computing platform 110 may be displayed on display device 132 or printed by printing device 134. Further as illustrated in FIG. 1, output module 130 may include a network output interface 136. Network output interface 136 may be operatively connected to communicate the output of computing platform 110 to an external computer, network and/or storage device (not shown), e.g., as a carrier wave.

Storage module 140 may include one or more computer readable media encoded with instructions and/or data (e.g., software applications, etc.) for use by computing platform 110 during the performance of one or more methods described below. Consistent with the present disclosure, a computer readable medium is any type of media that is capable of carrying instructions or data that may be used by computing platform 110 in the performance of one or more of the methods described below. Computer readable media include, for example, physical media (e.g., punch cards), magnetic media (e.g., magnetic disks or tapes), optical media (e.g., optical disks), or carrier waves (e.g., a signal from another computer or network, such as the Internet).

In exemplary embodiments of the present disclosure, storage module 140 may store a database system 200 containing data for use in one or more of the methods described below. Database system 200 may be implemented using commercial database access software (e.g., Microsoft Access, Sybase, Oracle, MySQL, SQL, etc.) that facilitates the location and retrieval of data stored in storage module 140.

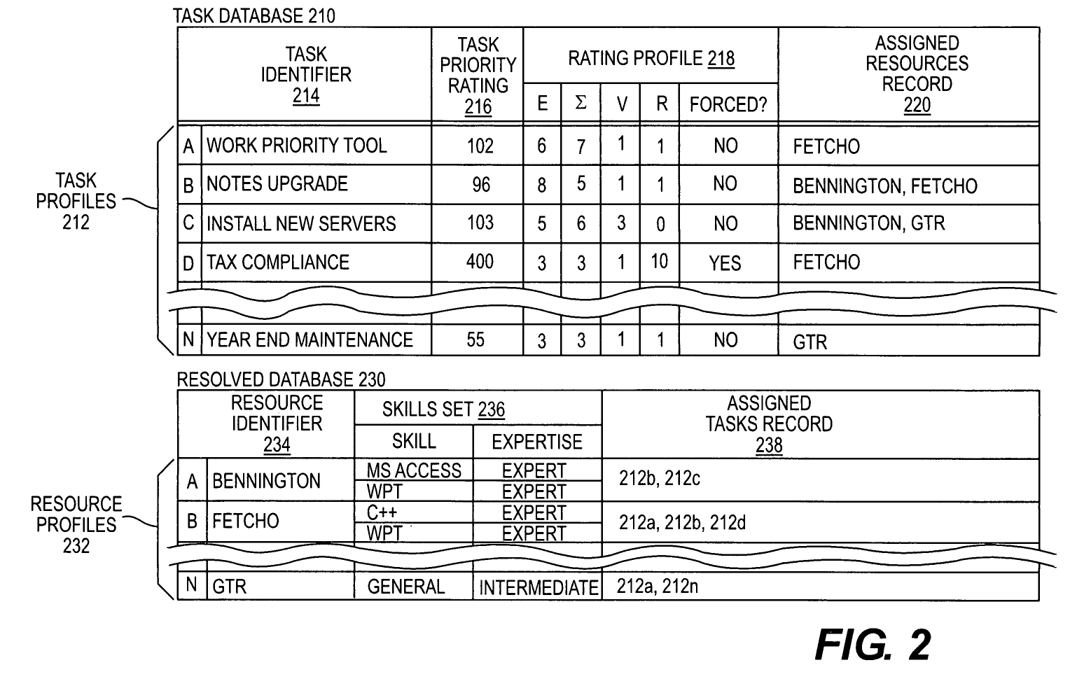

FIG. 2 illustrates data contained in an exemplary database system 200, consistent with the present disclosure. As shown in FIG. 2, database system 200 may include a task database 210 and a resource database 230.

Task database 210 may store a plurality of task profiles 212a-n related to various work items or tasks undertaken by the entity. As illustrated in FIG. 2, a given task profile 212 may link a plurality of records of data related to a particular task. For instance, task profile 212 may include a task identifier 214 and a task priority rating 216. Task identifier 214 may include a name, number or other descriptor suitable for distinguishing the various task profiles 212 in task database 210. Task priority rating 216 may include a numeric or other rating indicative of the relative priority of the tasks described in task database 210.

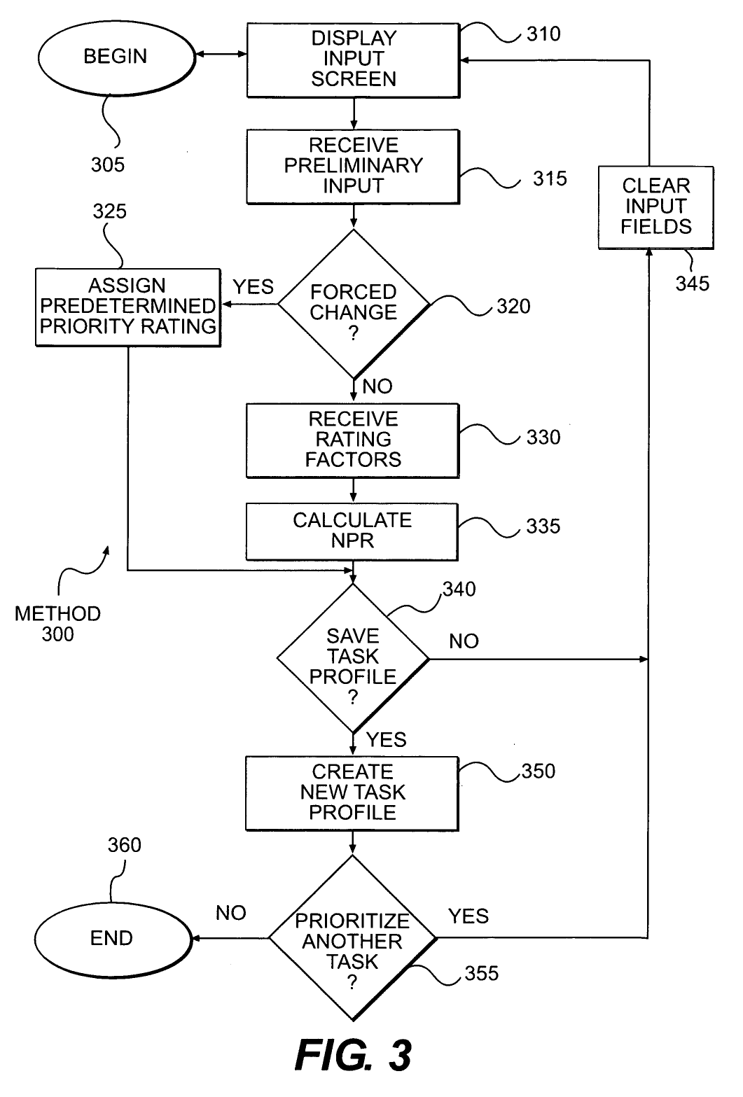

A method of assigning a normalized priority rating to a task is described below in connection with FIG. 3. The task priority rating 216 may be calculated by computing platform 110 based on one or more priority rating factors (“forced change,” E, Σ, V and R, discussed below in connection with FIG. 3). The values of these rating factors may be stored in a rating factor profile 218 within task profile 212. In exemplary embodiments of the present disclosure, a given task profile 212 may also contain an assigned resources record 220, which may contain a link to a list of resources (e.g., work groups or individuals) that have been assigned to the particular task.

A given task profile 212 may also contain other records (not shown) related to the particular task. For example, task profile 212 may contain records of dates related to project events (planned start date, implementation dates, cancellation date, etc.), project status (e.g., new, in-progress, on-hold, completed, cancelled, pending review, etc.), and/or the parties responsible for the task (e.g., supervisor, work group, etc.).

In addition, task profile 212 may contain a link to a list of sub-tasks or milestones (not shown) that may be used to track the progress of the task toward completion. Each sub-task may be described using a sub-task profile (not shown) having a structure similar to task profile 212. A given sub-task may be further divided into sub-sub-tasks in the same manner, and so on.

Resource database 230 may store a plurality of resource profiles 232 related to various resources of the entity, such as individual workers, work groups or contractors. As illustrated in FIG. 2, a given resource profile 232 may contain a plurality of records of data related to the particular resource. For instance, resource profile 232 may include a resource identifier 234, a skill set 236, and an assigned tasks record 238.

Resource identifier 234 may include a name, number or other descriptor suitable for distinguishing the various resource profiles 232 in resource database 230. Skill set 236 may contain a link to a list of the particular resource's skills or areas of expertise. For instance, where the resource is an individual programmer, skill set 236 may contain a list of programming languages or applications in which the programmer has experience, together with a rating of the programmer's level of experience (e.g., novice, intermediate, expert, etc.). Assigned tasks record 238 may contain a list of tasks assigned to the particular resource. For example, assigned tasks record 238 may contain a link to those task profiles 212 to which the particular resource has been assigned.

Storage module 140 may also store an application 250 (that is, software or program instructions) for performing one or more methods consistent with the present disclosure. Exemplary methods are described below with respect to FIGS. 3-6.

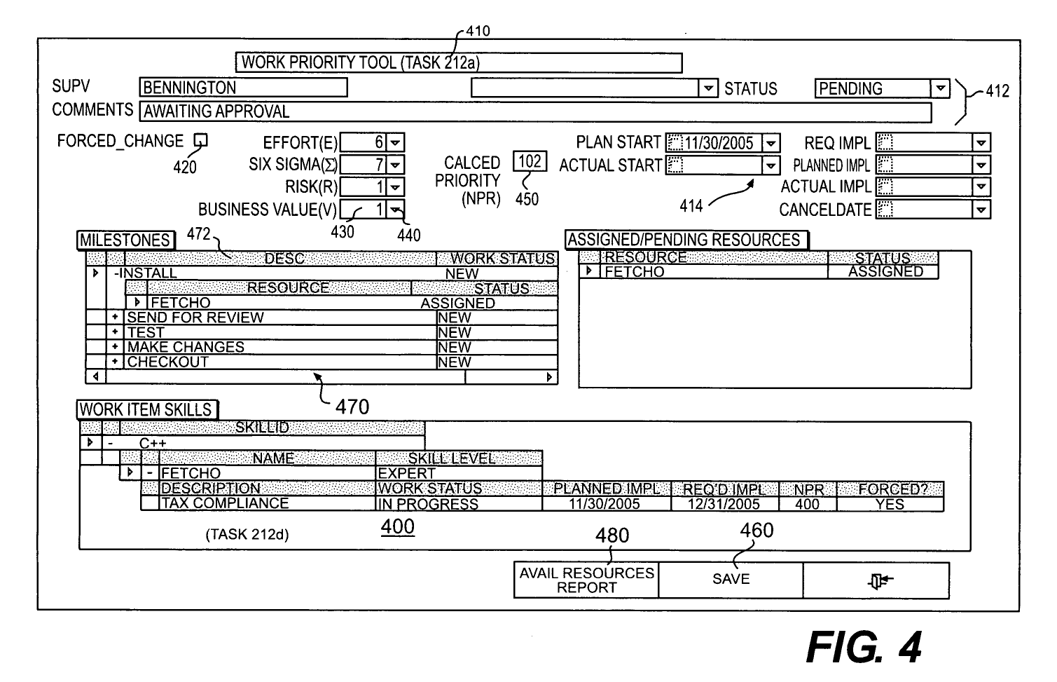

FIG. 3 is a flow chart illustrating an exemplary method 300 for assigning a normalized priority rating to a task, consistent with the present disclosure. In an exemplary embodiment of the present disclosure, application 250 may include instructions and/or data for configuring computing platform 110 to perform method 300 at the request of a user. FIG. 4 is an exemplary rating screen display 400, consistent with the present disclosure.

Method 300 receives input indicative of the characteristics of a task and assigns a normalized priority rating to the task based on the input. In an exemplary method, the normalized priority rating is a numerical value between 0 and 400, with a rating of “400” indicating the highest priority rating. However, it is to be understood that any other suitable rating scale or method of indicating the relative priority of tasks may be utilized, without departing from the scope of the present disclosure. For example, the numeric scale may be configured to place tasks in order of priority (e.g., with a rating of “1” indicating the highest priority task). Alternatively, the numeric scale may be replaced with another scale, such as color coding, a letter rating (e.g., A, B, C, etc.), or a descriptor (e.g., “high” or “low” priority), etc.

Method 300 will now be described with reference to rating display 400. Method 300 may begin at 305 when a user selectively activates or commands application 250 to perform the method for assigning a normalized priority rating to a particular task. The task may be any type of task that may be performed by an individual or entity, such as a business or government entity. For example, the task may be a software upgrade, a change in work-flow on an assembly line, a change in legal or accounting procedures, etc.

At 310, application 250 may present an input screen to the user and await user input. For example, application 250 may present exemplary rating display 400 to the user, e.g., on display device 132.

At 315, application 250 may receive preliminary input from the user. In an exemplary embodiment, the user may enter a task identifier in the description field 410 of rating display 400. Optionally, the user may enter other data in appropriate fields of display 400. For example, the user may enter data in fields 412 indicating project status (e.g., new, in-progress, on-hold, completed, cancelled, pending review, etc.), and/or the parties responsible for the task (e.g., supervisor, work group, etc.). The user may also enter data in fields 414 indicative of dates related to project events (planned start date, implementation dates, cancellation date, etc.).

At 320, application 250 may receive a user input indicating whether the particular task is “forced,” that is, whether the entity may be required to perform the task (e.g., in order to comply with applicable laws or generally accepted accounting principles, etc.). In exemplary rating display 400, for example, the user may indicate that the task is forced by checking a “Forced Change” box 420 in display 400.

If the task is forced (320: Yes), then application 250 may assign a predetermined value to the normalized priority rating 216 for the task, at 325. The predetermined value may be the maximum value priority rating (e.g., “400” in the exemplary embodiment). Processing may then continue at 340 below.

If the task is not forced (320: No), then application 250 may receive further user input (at 330) with respect to factors that may be used to calculate a normalized priority rating for the task. In an exemplary embodiment, application 250 may calculate the normalized priority rating (NPR) according to the following formula:
NPR=E·C_{E}+Σ·C_{Σ}+V·C_{V}+R·C_{R} (Equation 1)
where: E, Σ, V and R are user-assigned ratings that may be descriptive of certain characteristics of the particular task; and C_{E}, C_{Σ,}C_{V} and C_{R} are predetermined coefficients that may be used to give relative weight to the ratings E, Σ, V and R for each task entered into task database 210. In an exemplary embodiment, factors E, Σ, V and R are the only factors that are considered when assigning the normalized priority rating. However, it will be understood by those skilled in the art that fewer or additional factors may be considered, without departing from the scope of the present disclosure.

The values of factors E, Σ, V and R may vary with each task entered into task database 210. The user may enter numeric ratings in appropriate ratings fields 430 of exemplary rating display 400 for each task that is to be prioritized using method 300, e.g., using a keyboard. Alternatively, the user may use a mouse or other pointing device to activate a menu listing the possible values for each factor (e.g., by clicking on a drop-down menu icon 440 corresponding to the appropriate field 430). By contrast, application 250 may retrieve the values of coefficients C_{E}, C_{Σ,}C_{V} and C_{R} from storage module 140, and apply the same coefficient values each time method 300 is invoked.

With respect to the individual factors, factor E may be indicative of the level of effort necessary to complete the particular task. For example, the value of E may be determined by the user based on the number of worker-hours and/or wage hours estimated to be necessary to complete the task. In an exemplary embodiment, the value of E may be inversely proportional to the level of effort necessary to complete the task, i.e., so that (other factors being equal) tasks that may be accomplished with less effort are given a higher NPR. For example, the user may assign a value to E by inputting an integer rating corresponding to a given amount of worker-hours. In an exemplary embodiment, the user may assign a value to E in accordance with the following table:

TABLE 1
Exemplary Effort Rating Scale.

| Estimated worker-hours | E Rating |
|---|---|
| <5 hours | 10 |
| 5 hours-1 day | 9 |
| >1 day-3 days | 8 |
| >3 days-5 days | 7 |
| >5 days-2 weeks | 6 |
| >2 weeks-1 month | 5 |
| >1 month-2 months | 4 |
| >2 months-3 months | 3 |
| >3 months-6 months | 2 |
| >6 months | 1 |

In an alternative embodiment, the user may input an estimate of the number of worker hours or wage hours necessary to complete the task and application 250 may look up the corresponding value for E in Table 1, which may be stored in storage module 140.

Factor Σ may be indicative of the “Six Sigma” value or dollar benefit that is expected to be achieved by completing the task. For example, the value of Σ may be determined by the user based on the net dollar benefit to the entity (e.g., through costs savings or additional profits). The value of Σ may be directly proportional to the expected benefit, i.e., so that (other factors being equal) tasks that yield higher returns are given a higher NPR. For example, the user may assign a value to Σ by inputting an integer rating corresponding to a given dollar value. In an exemplary embodiment, the user may assign a value to Σ in accordance with the following table:

TABLE 2
Exemplary “Six Sigma” Rating Scale.

| Dollar Benefit | Σ Rating |
|---|---|
| >$850,000 | 10 |
| $700,001-$850,000 | 9 |
| $550,001-$700,000 | 8 |
| $400,001-$550,000 | 7 |
| $250,001-$400,000 | 6 |
| $100,001-$250,000 | 5 |
| $75,001-$100,000 | 4 |
| $50,001-$75,000 | 3 |
| $25,000-$50,000 | 2 |
| <$25,000 | 1 |

In an alternative embodiment, the user may input an estimate of the expected dollar benefit and application 250 may look up the corresponding value for Σ in Table 2, which may be stored in storage module 140.

It is to be understood that the rating assigned to a particular level of effort (E) or dollar benefit (Σ) may vary with the type of entity. For example, a smaller business may set the level of effort or dollar value corresponding to the highest rating at a lower level than a larger business, since a given level of effort or dollar benefit may be more significant to a smaller business than to a larger one.

Factor V may be indicative of the business value of the task, that is, the entity's need to perform the task based on, e.g., legal, tax, or accounting considerations, or on the entity's strategic position with respect to the competition. In an exemplary embodiment, the value of V may be directly proportional to the business value, i.e., so that (other factors being equal) a higher NPR is given to those tasks for which there is a greater business value. For example, the user may assign a value to V by inputting an integer rating corresponding to a subjective description of the business value. In an exemplary embodiment, the user may assign a value to V in accordance with the following table:

TABLE 3
Exemplary Business Value Rating Scale.

| Business Value | V Rating |
|---|---|
| High | 10 |
| Medium | 3 |
| Low | 1 |
| No Business Value | 0 |

Factor R may be indicative of the risk to the entity if it fails to perform the task. For example, the value of R may be determined by the user based on their estimate of the consequences of non-performance of the task. Risk may be thought of as the inverse of business value. Accordingly, the user may take some of the same legal, tax, and strategic consequences into consideration when assigning a value to R. In an exemplary embodiment, the value of R may be directly proportional to the risk due to non-performance, i.e., so that (other factors being equal) a higher NPR is given to those tasks that present greater risks if not undertaken. For example, the user may assign a value to R by inputting an integer rating corresponding to a subjective description of the risk. In an exemplary embodiment, the user may assign a value to R in accordance with the following table:

TABLE 4
Exemplary Risk Rating Scale.

| Risk if Not Completed | R Rating |
|---|---|
| High | 10 |
| Medium | 3 |
| Low | 1 |
| No Risk | 0 |

It should be noted that, in the exemplary embodiment, the maximum values of E, Σ, V and R are the same (each factor has a maximum value of ten). However, because the business value and risk may be harder to estimate than the either the level of effort necessary to perform a particular task, or the “Six Sigma” value or dollar benefit that may accrue through performance of the task, the exemplary embodiment provides fewer discrete values for the V and R ratings than it provides for either the E or Σ ratings. As shown in Tables 3 and 4, the values of V and R are limited to four discrete values (values of 0, 1, 3 and 10).

By limiting the possible values of V and R relative to E and Σ, the exemplary embodiment provides clearer guidance to the user in assigning a value to these factors, and increase the chances that the user will provide a thoughtful assessment of the business value and/or risk. For example, by allowing fewer values for R, the exemplary embodiment magnifies the difference between a task presenting potentially serious consequences if not performed and a task presenting only moderate consequences. If more discrete values are allowed (e.g., integer values 1-10), then users may tend to estimate the business value or risk of disparate tasks near the middle of the scale.

In addition, the difference between a “high” rating and a “medium” rating is further magnified by the disparity in their numeric rating values. That is, a task rated “low” on either the V or R scales receives a numeric rating of one, while a task that is rated at the next higher level (“medium” ) receives a numeric rating of three, and a task that is rated at the next higher level (“high”) receives a numeric rating of ten. The large numeric difference between the “medium” and “high” ratings guides users to rate as “high” only those tasks for which there is exceptional need or which present exceptional risks if not performed.

However, it is to be understood that the present disclosure is not to be limited to the integer scales used in the exemplary embodiment, and that other methods of assigning a value to factors E, Σ, V and R may be used. For example, the range of values used for E, Σ, V and/or R may allow a greater (or lesser) range of values than the ten-point scales illustrated in Tables 1-4, and may include decimal values. For example, screen display 400 may present a scroll bar or other sliding scale that would allow the user to assign a decimal value to one or more of factors E, Σ, V and R. Alternatively, the user may assign a value to the factors using a non-numeric scale. For example, rating display 400 may present the user with a choice of letter ratings (e.g., A, B, C), descriptors (e.g., high, medium or low) or color codes (e.g., red, yellow or green, etc.) for each rating. Application 250 may then look-up a numeric rating corresponding to the user input for use in calculating the NPR using Equation 1.

Further, the maximum values of E, Σ, V and R need not all be the same. For example, an alternative embodiment may provide a ten-point scale for factor E, a five point scale for factor Σ, and a three-point scale for factors V and R.

After the values of factors E, Σ, V and R have been received, computing platform may calculate the NPR according to Equation 1, at 335, and display the result in a priority rating field 450 of rating display 400. Specifically, application 250 may multiply the value of each factor E, Σ, V and R by its respective weighting coefficient C_{E}, C_{Σ,}C_{V} or C_{R} and add the resulting weighted factors together to determine the NPR. In an exemplary embodiment, the values of C_{E}, C_{Σ,}C_{V} and C_{R} are given by the following table.

TABLE 5
Exemplary Values of Weighting Coefficients.

| Coefficient | Value |
|---|---|
| C_{E} | 5 |
| C_{Σ} | 8 |
| C_{V} | 10 |
| C_{R} | 6 |

However, it is to be understood that the relative values of the weighting coefficients C_{E}, C_{Σ,}C_{V} and C_{R} may vary depending upon the type of entity. For example, the entity may vary the relative weight given to factors E, Σ, V and R over time based on their experience in using method 300.

At 340, the user may choose to save the output of method 300 in a new task profile 212, e.g., by actuating a “Save” button 460. If the user does not wish to save the output (340: No), then the user may instead clear input fields 410-450 of exemplary screen display (at 345) and return processing to 310.

If the user does wish to save the output (340: Yes), then computing platform may create a new task profile 212 in task database 210, at 350. For example, application 250 may store the task identifier input by the user in field 410, and the value of NPR calculated in records 214 and 216, respectively. Computing platform may also store the value of the forced change indicator 420 (i.e., true or false) and the values of E, Σ, V and R (input by the user in fields 430) in rating profile 218. Application 250 may also save any other preliminary user input, e.g., identifying applicable dates, and the associated supervisor, work group, etc., in appropriate records (not shown) in task profile 212.

After saving the new task profile 212, application 250 may present a prompt asking the user if they would like to prioritize another task, at 355. If so (355: Yes), then application 250 may clear input fields 410-450 (at 345) and return processing to 310. If the user does not wish to prioritize another task (355: No), then application 250 may end, at 360.

Once the task has been prioritized according to method 300, the user may choose which of several tasks to schedule for performance. For example, the user may schedule tasks for performance based upon their NPR ratings. With respect to tasks 212a-d represented in task database 210, for instance, the user may choose to schedule task 212d for performance ahead of any of tasks 212a-c based on the fact that task 212d has a much higher priority rating (NPR=400) than any of tasks 212a-c (due to the fact that task 212d represents a forced change). However, it may be less clear which of tasks 212a-c to schedule for performance ahead of the others, since (as shown in FIG. 2) they each have similar NPR values. Accordingly, the present disclosure provides a method for prioritizing tasks based on factors other than their final NPR values.

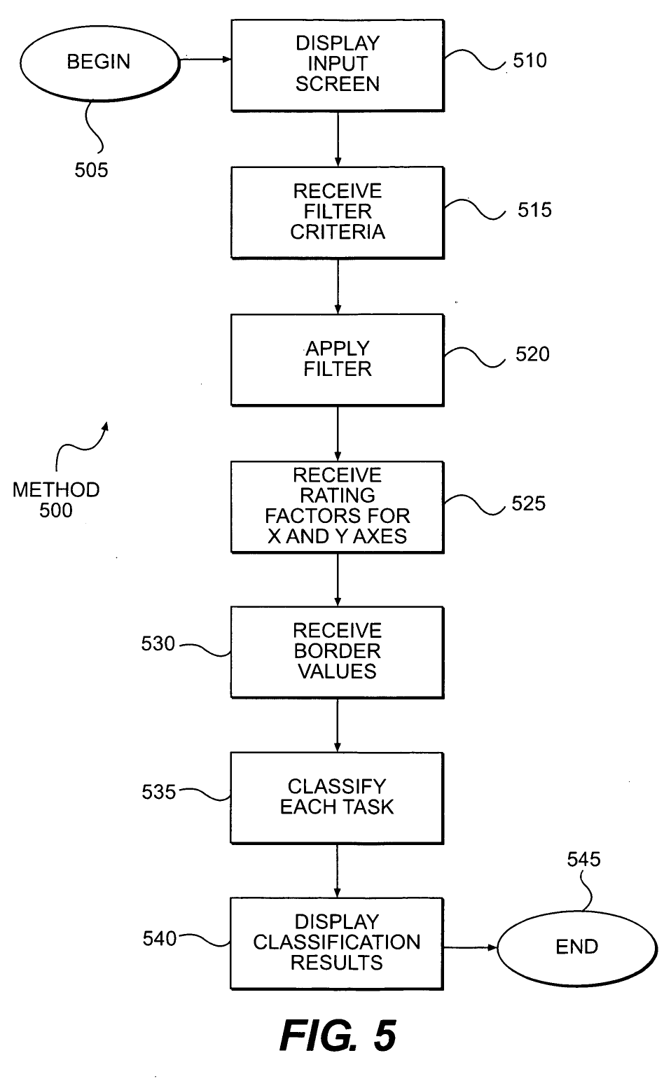

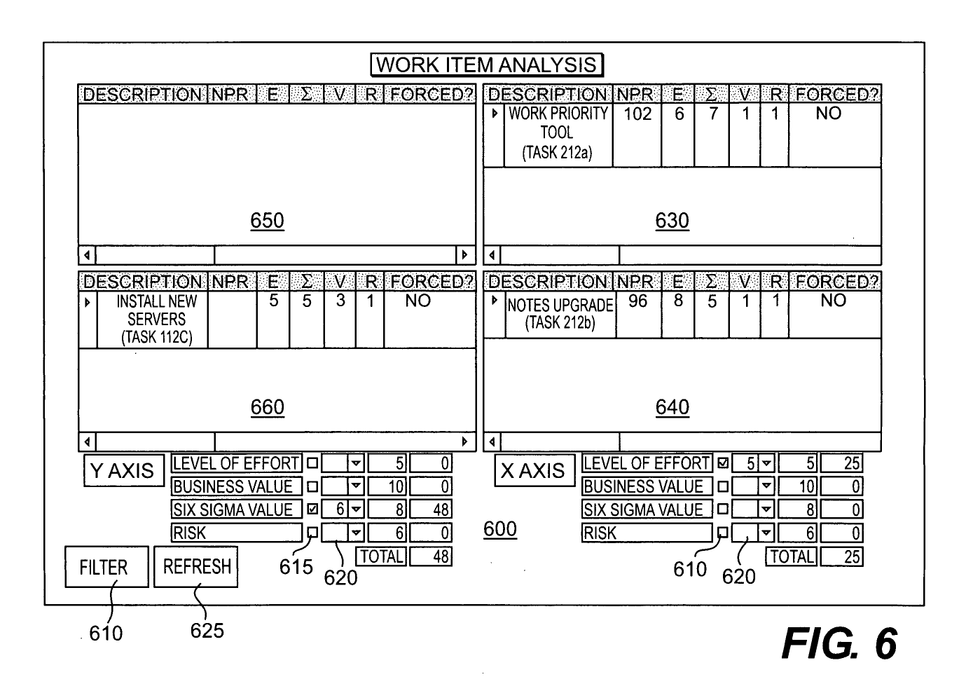

FIG. 5 is a flow chart illustrating an exemplary method 500 for classifying task profiles 212 based on their priority rating factors (e.g., E, Σ, V and/or R), consistent with the present disclosure. In an exemplary embodiment of the present disclosure, application 250 may include instructions and/or data for configuring computing platform 110 to perform method 500 at the request of a user. FIG. 6 is an exemplary classification screen display 600, consistent with the present disclosure.

Method 500 may be provided as a tool to allow users to decide which of several tasks should be undertaken by an entity. Method 500 receives input indicative of the desired characteristics of a task and outputs a display indicative of those task profiles 212 in task database 210 that meet or exceed the desired characteristics. In particular, method 500 may allow a user to search for task profiles 212 that meet desired minimums for the values of two or more priority rating factors E, Σ, V and/or R, and provides a graphical display indicating those tasks that meet the desired minimums.

Method 500 will now be described with reference to exemplary classification display 600. Method 500 may begin at 505 when a user selectively activates or commands application 250 to perform the classification method. At 510, application 250 may present an input screen to the user and await user input. For example, application 250 may present exemplary classification display 600 to the user, e.g., on display device 132.

At 515, application 250 may receive an input indicative of which task profiles 212 the user wishes to classify. For example, the user may actuate “Filter” button 610 in order to select particular task profiles 212 using a pop-up filter menu (not shown). The filter menu may allow the user to select particular task profiles 212a-n from a list of all task profiles 212 in task database 210. The filter menu may also allow the user to search for task profiles 212 meeting certain criteria. For example, the filter menu may allow the user to select all task profiles 212 associated with a particular supervisor, work group, or system, etc. The filter menu may also allow the user to select all task profiles having NPR values in a given range.

Upon selection of the filter criteria, application 250 may apply the filter (at 520) by searching task database 210 for those task profiles 212 that meet the filter criteria. Those task profiles 212 that meet all of the filter criteria are included in the search group. Those task profiles 212 that fail to meet one or more of the filter criteria are filtered (i.e., excluded) from the search group. In the discussion that follows, it will be assumed that only task profiles 212a-c are included in the search group.

At 525, application 250 may receive an input indicative of the priority rating factors (e.g., E, Σ, V and/or R) that the user wishes to use to classify the task profiles 212 in the search group. As shown in exemplary classification display 600, the user may choose at least one priority rating factor for classification along the x-axis and at least one priority rating factor for classification along the y-axis. In the exemplary embodiment, the user may select one or more factors for classification along each axis by checking a box 615 corresponding to the desired factor or factors, e.g., using a mouse or other pointing device.

In exemplary classification display 600, for example, the user has chosen the Effort factor (E) for classification along the x-axis and the Six Sigma value factor (Σ) for classification along the y-axis, by checking the corresponding box 615. However, the number of factors classified along the x and y axes need not be equal. For example, the user may choose the effort factor (E) for classification along the x-axis and choose both the business value and risk factors (V and R) for classification along the y-axis. However, in the exemplary embodiment, the same factor may not be chosen for classification along both the x and y axes.

Application 250 may then receive an indication of the values of the priority rating factors to be used in the classification, at 530. In the exemplary search display 600, for example, the user may enter numeric ratings in appropriate fields 620 to indicate a value for each of the selected factors. For example, the user may use a keyboard to input a numeric rating into fields 620 corresponding to the selected factors. Alternatively, the user may use a mouse or other pointing device to activate a menu listing the possible values for each factor, as described above with respect to FIG. 4. In exemplary classification display 600, the user has entered the value “5” for the x-axis factor (E) and has entered the value “6” for the y-axis factor (Σ).

In an exemplary embodiment, the values entered in fields 620 may represent the border between the positive and negative x and y axes. Those task profiles 212 in the search group that have rating profiles 218 that exceed the border value for the selected factor may be represented on the positive axis. Those task profiles 212 in the search group that have rating profiles 218 that are less than or equal to the border value for the selected factor may be represented on the negative axis, as discussed below. In an alternative embodiment, those task profiles 212 having rating profiles 218 that are equal to the border value for the selected factor may be represented on the positive axis.

After the desired border values for each selected factor have been entered, the user may invoke a classification function of application 250 in order to classify the selected task profiles 212 according to whether their rating profiles 218 exceed the border values with respect to the selected factors. For example, the user may actuate a “Refresh” button 625 in order to invoke the classification function. Application 250 may then search the selected task profiles 212 and classify each task profile in the search group along both the x and y axes based on whether the rating profile 218 of the particular task profile exceeds the border values for the selected factors (at 535).

At 540, application 250 may display the results of the classification in classification display 600. If a given task profile 212 has a rating profile 218 that exceeds the border value of one or more of the factors selected for classification along the x-axis, then that task profile may be represented on the positive x-axis. If a given task profile 212 has a rating profile 218 that exceeds the border value of one or more of the factors selected for classification along the y-axis, then that task profile may be represented on the positive y-axis.

Accordingly, those task profiles 212 having rating profiles 218 that exceed the border value of an x-axis factor and the border value of a y-axis factor will be displayed in a first (+x, +y) quadrant 630 of classification display 600; those task profiles 212 having rating profiles 218 that exceed the border value of an x-axis factor, but not the border value of a y-axis factor will be displayed in a second (+x, −y) quadrant 640 of classification display 600; those task profiles 212 having rating profiles 218 that exceed the border value of a y-axis factor, but not the border value of an x-axis factor will be displayed in a third (−x, +y) quadrant 650 of classification display 600; and those task profiles 212 having rating profiles 218 that exceed none of the border values will be displayed in a fourth (−x, −y) quadrant 660 of classification display 600.

In the exemplary classification display 600, for example, task profile 212a is displayed in the first (+x, +y) quadrant 630, since its rating profile (E=6, Σ=7, V=1, R=1) exceeds both the border value (5) of the selected x-axis factor (E) and the border value (6) of the selected y-axis factor (Σ) task profile 212b is displayed in the second (+x, −y) quadrant 640, since its rating profile (E=8, Σ=5, V=1, R=1) exceeds the border value of the x-axis, but not the border value of the y-axis; and task profile 212c is displayed in the fourth (−x, −y) quadrant 660, since its rating profile (E=5, Σ=6, V=3, R=0) fails to exceed the border value of either the x or the y axis.

In this manner, classification display 600 may be used to select which of several proposed tasks having similar priority ratings should be selected for performance by the entity. For example, task profiles 212a and 212c have similar priority ratings: the NPR of task 212a is 102, while the NPR of task 212c is 103. However, task profile 212a represents a relatively low effort (E=6, representing more than five worker-days but less than two worker-weeks of work) but high value task (Σ=7, representing an expected value of $400,001-$550,000). Thus task 212a may be considered to be more desirable to perform than task 212c, which represents a relatively higher effort (E=5, representing more than two worker-weeks, but less than one worker-month of work) and relatively lower value task (Σ=6, representing an expected value of $250,001-$400,000). Accordingly, the user may select task 212a for performance in advance of the performance of task 212c, despite the fact that task 212c has a higher NPR than task 212a.

Once a task has been selected for performance, the user may divide the task into a plurality of sub-tasks or milestones and assign resources to complete each sub-task. For example, the user may call up the exemplary rating display 400 of FIG. 4 for a particular task profile (e.g., task profile 212a) by selecting the identifier 214 for the task within display 600, e.g., using a mouse or other pointing device. Application 250 may then retrieve the task profile 212 for the particular task and present the user with the rating display 400 (see FIG. 4) for that task profile. In this case, however, rating display 400 may already be populated with the values previously entered in fields 410-450.

The user may divide the task into subtasks by navigating to a “Milestones” section 470 of rating display 400, e.g., using user input device 122. The user may enter one or more sub-tasks for the particular task by entering appropriate text in the description fields 472 of section 470. Alternatively, the user may retrieve a milestone template (not shown) from storage module 140. The milestone template may list sub-tasks that are commonly performed during the completion of a particular category or type of tasks.

Application 250 may then create a sub-task profile (not shown) linked to task profile 212a in task database 210. The NPR of the sub-task profile may be the same as the NPR of the associated task profile 212. The user may also determine the types of skills that are necessary to complete the subtask and associate the sub-task with a skill-set necessary to complete the sub-task, e.g., by indicating necessary skill-set and level of expertise in an appropriate record (not shown) in the sub-task profile.

The user may then assign resources to the sub-task by matching resources having the necessary expertise. In the exemplary embodiment, for example, the user may actuate an “Available Resources Report” button 480 to invoke a search for resources that have both the expertise necessary to complete the work and the capacity to take on new work. Upon invocation of the search function, application 250 may generate a list of available resources.

For example, application 250 may search skill set records 236 of resource database 230 for those resources having the required skill set and level of expertise. For the subset of resources that have the necessary expertise, application 250 may then search the assigned task records 238 of each resource to determine whether the particular resource has the capacity to take on new work. For instance, application 250 may compare the NPR of the proposed sub-task with the NPR of each of the assigned tasks listed in assigned task record 238 for the particular resource. If the proposed sub-task has a lower priority rating than those tasks already assigned to the resource for completion within the time frame of the subtask, then application 250 may remove the resource from the list of available resources.

Application 250 may then return a listing (e.g., in a drop down menu, not shown) of the identifiers 234 of those resources having both the necessary expertise and the capacity to complete the work in the allotted time frame. The user may assign the sub-task to a particular resource from the listing, and application 250 may update the assigned task record 238 in the profile 232 for the particular resource to reflect the addition of the newly assigned sub-task.

### INDUSTRIAL APPLICABILITY

The presently disclosed systems and methods for prioritizing tasks allow dissimilar tasks to be normalized and prioritized according to their relative effects on the quality of output. By assigning normalized priority ratings to tasks, entities are able to mathematically compare dissimilar work efforts through normalization and increase business value by focusing on those tasks that make the highest contribution toward the goal of increasing quality.

The foregoing description of embodiments of the disclosure has been presented for purposes of illustration and description. It is not exhaustive and does not limit the disclosure to the precise form disclosed. Modifications and variations are possible in light of the above teachings or may be acquired from practicing of the disclosure. While the exemplary methods have been described herein as a series of acts, the order of the acts may vary in other implementations consistent with the present disclosure. In particular, non-dependent acts may be performed in any order, or in parallel.

What is claimed is:

1. A computer-implemented method for calculating a normalized priority rating for a task, the method comprising:
a computer receiving an indication of whether the task is a forced change;
if the task is a forced change, the computer assigning a predetermined normalized priority rating to the task; and
if the task is not a forced change, the computer receiving input indicative of a plurality of task characteristics and calculating a normalized priority rating based on the task characteristics; and
the computer providing an output indicative of the normalized priority rating.

2. The method of claim 1, wherein the normalized priority rating has a maximum value and the predetermined normalized priority rating equals the maximum value.

3. The method of claim 1, wherein the task characteristics consist essentially of: (a) a rating indicative of effort necessary to complete the task; (b) a rating indicative of monetary benefits flowing from completion of the task; (c) a rating indicative of business need to perform the task; and (d) a rating indicative of business risk due to non-performance of the task.

4. The method of claim 1, wherein calculating a priority rating comprises calculating a normalized priority rating in accordance with the equation:
NPR=E·C_{E}+Σ·C_{Σ}+V·C_{V} +R·C_{R}
where:
NPR is the normalized priority rating;
E is an input having a value indicative of effort necessary to complete the task;
Σ is an input having a value indicative of monetary benefits flowing from completion of the task;
V is an input having a value indicative of business need to perform the task;
R is an input having a value indicative of business risk due to non-performance of the task; and
C_{E}, C_{Σ}, C_{V}, and C_{R} are predetermined weighting coefficients.

5. The method of claim 4, wherein the values of inputs E, Σ, V and R are each selected from a set consisting of a finite number of discrete numeric values.

6. The method of claim 5, wherein the values of inputs E and Σ are selected from a first set of values, and the values of V and R are selected from a subset of the first set of values.

7. The method of claim 4, wherein the value of input E is inversely related to the effort necessary to complete the task.

8. The method of claim 1, wherein the output comprises one of (a) a display, (b) a printout (c) a database entry, or (d) a carrier wave.

9. The method of claim 1, further comprising calculating a normalized priority rating for at least first and second tasks and scheduling work on the tasks based on their relative normalized priority ratings.

10. The method of claim 1, further comprising comparing the normalized priority rating of a first task to a normalized priority rating of a second task previously assigned to a resource, and determining whether to assign the first task to the resource based on the comparison.

11. A computer-readable media containing instructions for configuring a processor to perform a method for calculating a normalized priority rating for a task, the method comprising:
receiving an indication of whether the task is a forced change;
if the task is a forced change, assigning a predetermined normalized priority rating to the task; and
if the task is not a forced change, receiving input indicative of a plurality of task characteristics and calculating a normalized priority rating based on the task characteristics; and
providing an output indicative of the normalized priority rating.

12. The computer-readable media of claim 11, wherein the normalized priority rating has a maximum value and the predetermined normalized priority rating equals the maximum value.

13. The computer-readable media of claim 11, wherein the task characteristics consist essentially of: (a) a rating indicative of effort necessary to complete the task; (b) a rating indicative of monetary benefits flowing from completion of the task; (c) a rating indicative of business need to perform the task; and (d) a rating indicative of business risk due to non-performance of the task.

14. The computer-readable media of claim 11, wherein calculating a priority rating comprises calculating a normalized priority rating in accordance with the equation:
NPR=E·C_{E}+Σ·C_{Σ}+V·C_{V}+R·C_{R}
where:
NPR is the normalized priority rating;
E is an input having a value indicative of effort necessary to complete the task;
Σ is an input having a value indicative of monetary benefits flowing from completion of the task;
V is an input having a value indicative of business need to perform the task;
R is an input having a value indicative of business risk due to non-performance of the task; and
C_{E}, C_{Σ}, C_{V}, and C_{R} are predetermined weighting coefficients.

15. The computer-readable media of claim 14, wherein the values of inputs E, Σ, V and R are each selected from a set consisting of a finite number of discrete numeric values.

16. The computer-readable media of claim 15, wherein the values of inputs E and Σ are selected from a first set of values, and the values of V and R are selected from a subset of the first set of values.

17. The computer-readable media of claim 14, wherein the value of input E is inversely related to the effort necessary to complete the task.

18. The computer-readable media of claim 11, wherein the output comprises one of (a) a display, (b) a printout (c) a database entry, or (d) a carrier wave.

19. The computer-readable media of claim 11, the method further comprising calculating a normalized priority rating for at least first and second tasks and scheduling work on the tasks based on their relative normalized priority ratings.

20. The computer-readable media of claim 11, the method further comprising comparing the normalized priority rating of a first task to a normalized priority rating of a second task previously assigned to a resource, and determining whether to assign the first task to the resource based on the comparison.

21. A system for calculating a normalized priority rating for a task, the system comprising:
a computing platform configured to:
receive an indication of whether the task is a forced change;
if the task is a forced change, assign a predetermined normalized priority rating to the task; and
if the task is not a forced change, receive input indicative of a plurality of task characteristics and calculate a normalized priority rating based on the task characteristics; and
provide an output indicative of the normalized priority rating.

22. The system of claim 21, wherein the normalized priority rating has a maximum value and the predetermined normalized priority rating equals the maximum value.

23. The system of claim 21, wherein the task characteristics consist essentially of: (a) a rating indicative of effort necessary to complete the task; (b) a rating indicative of monetary benefits flowing from completion of the task; (c) a rating indicative of business need to perform the task; and (d) a rating indicative of business risk due to non-performance of the task.

24. The system of claim 21, wherein calculating a priority rating comprises calculating a normalized priority rating in accordance with the equation:
NPR=E·C_{E}+Σ·C_{Σ}+V·C_{V}+R·C_{R}
where:
NPR is the normalized priority rating;
E is an input having a value indicative of effort necessary to complete the task;
Σ is an input having a value indicative of monetary benefits flowing from completion of the task;
V is an input having a value indicative of business need to perform the task;
R is an input having a value indicative of business risk due to non-performance of the task; and
C_{E}, C_{Σ}, C_{V}, and C_{R} are predetermined weighting coefficients.

25. The system of claim 24, wherein the values of inputs E, Σ, V and R are each selected from a set consisting of a finite number of discrete numeric values.

26. The system of claim 25, wherein the values of inputs E and Σ are selected from a first set of values, and the values of V and R are selected from a subset of the first set of values.

27. The system of claim 24, wherein the value of input E is inversely related to the effort necessary to complete the task.

28. The system of claim 21, wherein the output comprises one of (a) a display, (b) a printout (c) a database entry, or (d) a carrier wave.

29. The system of claim 21, the computing platform further configured to calculate a normalized priority rating for at least first and second tasks and schedule work on the tasks based on their relative normalized priority ratings.

30. The system of claim 21, the computing platform further configured to compare the normalized priority rating of a first task to a normalized priority rating of a second task previously assigned to a resource, and determine whether to assign the first task to the resource based on the comparison.
